(19) United States
(12) Patent Application Publication
(10) Pub. No.: US 2022/0276711 A1
(43) Pub. Date: Sep. 1, 2022

(54) POSITION/FORCE CONTROLLER, AND POSITION/FORCE CONTROL METHOD AND STORAGE MEDIUM

(71) Applicants: KEIO UNIVERSITY, Minato-ku, Tokyo (JP); Motion Lib, Inc., Kawasaki-shi, Kanagawa (JP)

(72) Inventors: Kouhei OHNISHI, Kanagawa (JP); Takahiro MIZOGUCHI, Kanagawa (JP)

(73) Assignees: KEIO UNIVERSITY, Minato-ku, Tokyo (JP); Motion Lib, Inc., Kawasaki-shi, Kanagawa (JP)

(21) Appl. No.: 17/633,044

(22) PCT Filed: Aug. 5, 2020
(86) PCT No.: PCT/JP2020/030081

§ 371 Date: Feb. 4, 2022

(30) Foreign Application Priority Data
Aug. 5, 2019 (JP) 2019-144073

(51) Int. Cl. G06F 3/01; G06F 3/041

(52) U.S. Cl. CPC G06F 3/016; G06F 3/041

(57) ABSTRACT

A position/force controller includes a control unit and an impedance estimation unit. The control unit acquires a parameter that is generated under position and force control that is implemented in response to a touch of an object to be touched. The impedance estimation unit estimates impedance of the object to be touched, based on the parameter that is acquired by the control unit.

### TECHNICAL FIELD

The present invention relates to a position/force controller that controls positions and forces of a control object, and to a position/force control method and program.

### BACKGROUND ART

In recent years, techniques in position and force control for transmitting the sense of touch of an object have been developed.

The techniques in the position and force control for transmitting the sense of touch of the object are used, for example, for a robot to hold the object with appropriate force or for a master-slave system to transmit force tactile sensation between a master and a slave.

A technique in the position and force control described above is disclosed in, for example, PTL 1.

### CITATION LIST

### Patent Literature

[PTL 1]: International Publication No. 2015/041046

### SUMMARY OF INVENTION

### Technical Problem

As for an existing technique in the position and force control for transmitting the sense of touch of the object, however, it is difficult to acquire information about texture that represents the sense of touch of an object surface and to provide the information to a user, whereas characteristics such as the size and hardness of the object can be transmitted.

In particular, in the case where the texture of an object that is touched in virtual space is provided to the user, it is necessary for a device that is used by the user to mechanically reproduce the texture. However, such control cannot be provided by the existing technique in the position and force control.

It is thus difficult for the existing technique to appropriately acquire or provide the sense of touch of the object including the texture of the object.

It is an object of the present invention to appropriately acquire or provide the sense of touch of an object.

### Solution to Problem

In order to achieve the object described above, a position/force controller according to an aspect of the present invention comprising:

a parameter acquisition means that acquires a parameter that is generated under position and force control that is implemented in response to a touch of an object to be touched; and

an impedance estimation means that estimates impedance of the object to be touched, based on the parameter that is acquired by the parameter acquisition means.

A position/force controller according to another aspect of the present invention comprising:

a position acquisition means that acquires a position in a direction perpendicular to a plane and a position in a direction of the plane on an object surface of an object to be touched; and

a force tactile sensation provision means that provides force tactile sensation including texture that represents sense of touch of the object surface by implementing position and force control of a position and force that are outputted by an actuator at the position in the direction perpendicular to the plane and the position in the direction of the plane on the object surface of the object to be touched that are acquired by the position acquisition means, based on a function that uses impedance of the object to be touched as an eigenvalue and that uses the position in the direction perpendicular to the plane and the position in the direction of the plane on the object surface as variables for calculating reaction force from the object to be touched.

### Advantageous Effects of Invention

According to the present invention, the sense of touch of an object can be appropriately acquired or provided.

### BRIEF DESCRIPTION OF DRAWINGS

FIG. 1 schematically illustrates the concept of the sense of touch of the object according to the present invention.

FIG. 2 schematically illustrates the concept of the sense of touch of the object in the case where it is thought that the stiffness, the viscosity, and the inertia change at the touch position on the object to be touched.

FIG. 3 schematically illustrates a state in which the impedance of the object is acquired by implementing the position control, the velocity control, or the force control.

FIG. 4 is a block diagram illustrating an example of the structure of the position/force controller 1 in the case where the impedance of the object is acquired by implementing the position control, the velocity control, or the force control.

FIG. 5 is a block diagram illustrating a control algorithm that is implemented in the control unit 20.

FIG. 6 is a flowchart illustrating the flow of the impedance estimation process that is performed by the position/force controller 1.

FIG. 7 is a flowchart illustrating the flow of the force tactile sensation provision process that is performed by the position/force controller 1.

FIG. 8 schematically illustrates a state in which the impedance of the object is acquired by transmitting the force tactile sensation between the master and the slave.

FIG. 9 is a block diagram illustrating an example of the structure of the position/force controller 1 in the case where the impedance of the object is acquired by transmitting the force tactile sensation between the master and the slave.

FIG. 10 schematically illustrates an example of the implementation form of the position/force controller 1 according to the present modification.

FIG. 11 is a block diagram illustrating a control algorithm that is implemented in the control unit 20 according to the first modification.

### DESCRIPTION OF EMBODIMENTS

Herebelow, an embodiment of the present invention is described with reference to the attached drawings.

First, a basic principle employed in the position/force controller, position/force control method and program according to the present invention is described.

### [Basic Principle]

According to the present invention, information about force tactile sensation when an object is touched including texture that represents the sense of touch of an object surface is acquired and provided by a device.

According to the present invention, the impedance of the object to be touched is estimated to acquire the information about the force tactile sensation when the object is touched.

When the impedance is estimated, coordinate conversion of a parameter in real space into that in a coordinate system in which a position and force can be independently used is carried out to perform a computation regarding the force tactile sensation when the object is touched. The coordinate conversion is defined as conversion that represents a function of controlling the force tactile sensation, and one disclosed in International Publication No. 2015/041046 as coordinate conversion that represents a function of transmitting the force tactile sensation, for example, can be used. The concept of the function of controlling the force tactile sensation includes controlling the force tactile sensation that humans can feel and controlling, for example, a position, velocity, or force that is outputted by a machine.

Coordinate conversion of an input vector that represents a position and force in the real space into a vector in the coordinate system described above is carried out based on the position of an output shaft (or a member that conjunctively operates) of an actuator. In the coordinate system, a computation for causing a state value (a vector element) that is acquired by the coordinate conversion to follow a target value for fulfilling the function of controlling the force tactile sensation is performed.

Reverse conversion of the result of the computation in the coordinate system described above into a parameter in the real space is carried out, and the actuator is controlled based on the parameter. Consequently, the function of controlling the force tactile sensation is fulfilled, and the impedance (stiffness, viscosity, and inertia) of the object to be touched is estimated based on the parameter that is acquired under a series of the control.

According to the present invention, the sense of touch (specifically, the force tactile sensation including the texture that represents the sense of touch of the object surface) of the object surface in the real space or virtual space can be provided by using the estimated impedance.

According to the present invention, the stiffness, the viscosity, and the inertia (the impedance) of the object to be touched are regarded as being inherent, and reaction force from the object is defined as a function depending on a position in a direction perpendicular to a plane and a position in a direction of the plane on the object surface in order to provide the sense of touch of the object surface. Consequently, the texture that represents the sense of touch of the object surface is informatized.

Specifically, the sense of touch of the object to be touched is defined based on an equation of motion that is expressed as a function in which the stiffness, the viscosity, and the inertia are constants, and a position that determines an action on and a reaction from the object includes, as elements, the position in the direction perpendicular to the plane and the position in the direction of the plane on the object surface.

In the case where the position in the direction perpendicular to the plane and the position in the direction of the plane on the object surface are given as an input in the real space or the virtual space, a value that is determined by a function that defines the sense of touch of the object to be touched is inputted as a reference value, the computation for following the target value is performed in the coordinate system described above, and the output of the actuator is controlled. Consequently, the force tactile sensation including the texture that represents the sense of touch of the object surface can be provided.

A position and velocity (or acceleration) or an angle and angular velocity (or angular acceleration) are parameters that can be replaced by calculus. Accordingly, in the case where processing regarding the position or the angle is performed, these can be appropriately replaced with, for example, the velocity or the angular velocity.

### [Function Representing Sense of Touch of Object]

According to the present invention, the stiffness, the viscosity, and the inertia (the impedance) of the object to be touched are regarded as being inherent, and the sense of touch of the object is defined as the function depending on the position in the direction perpendicular to the plane and the position in the direction of the plane on the object surface. Consequently, the texture that represents the sense of touch of the object surface is informatized as described above.

The sense of touch (the force tactile sensation including the texture that represents the sense of touch of the object surface) of the object is affected by not only the shape of the object surface but also physical characteristics of the object itself. Accordingly, in the case where the sense of touch of the object is defined, it is effective to reflect the impedance of the object.

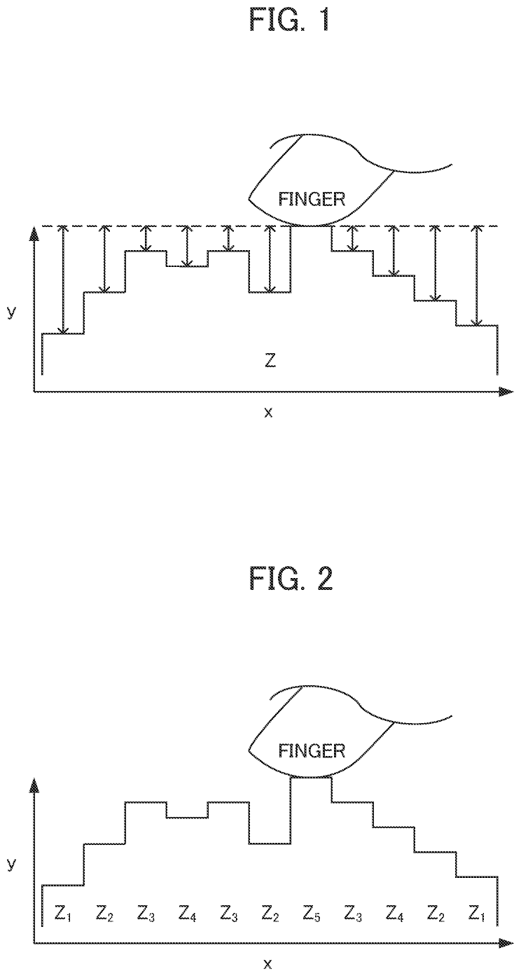

FIG. 1 schematically illustrates the concept of the sense of touch of the object according to the present invention.

As illustrated in FIG. 1, in the case where the shape of the object surface to be touched is not a smooth surface but has fine unevenness, it is thought that the impedance (the stiffness, the viscosity, and the inertia) of the object itself does not change, and the shape (the contour) of the surface changes.

In this case, it can be said that an appropriate way of thinking about a phenomenon is to think that a parameter Z that represents the impedance of the object does not change, and the reaction force from the object changes depending on a touch position (the position y in the direction perpendicular to the plane and the position x in the direction of the plane on the object surface).

In view of this, according to the present invention, the sense of touch of the object is defined by using the stiffness, the viscosity, and the inertia inherent in the object and information about the contour of the object surface.

Specifically, the sense of touch of the object is defined as the following expressions (1) and (2).

[Math. 1]

f=m\ddot{x}+d\dot{x}+kx (1)

X=g(y,t) (2)

In the expressions (1) and (2), f is the reaction force from the object to be touched, m is the inertia, d is the viscosity, k is the stiffness, g is a function that represents the contour of the object surface, and t is time. The function that represents the contour of the object surface is a function of the time t. Accordingly, the expression (2) represents the contour of the object surface the shape of which changes depending on, for example, a touch.

In this case, parameters to be managed to acquire or provide the sense of touch are the stiffness, the viscosity, and the inertia (the impedance) inherent in the object, and the position in the direction perpendicular to the plane and the position in the direction of the plane on the object surface, and the sense of touch can be acquired or provided by using a decreased number of the parameters.

In the case where it is thought that the stiffness, the viscosity, and the inertia change (that is, the impedance changes depending on the touch position) at the touch position on the object to be touched, it is thought that the stiffness, the viscosity, and the inertia of the object to be touched are represented by the function depending on the position in the direction of the plane on the object surface touched.

FIG. 2 schematically illustrates the concept of the sense of touch of the object in the case where it is thought that the stiffness, the viscosity, and the inertia change at the touch position on the object to be touched.

In the concept illustrated in FIG. 2, it is thought that impedance Z₁ to Z₅ changes depending on the position x in the direction of the plane on the object surface touched. Accordingly, the sense of touch of the object is expressed as the following expression (3).

[Math. 2]

f=m(x)\ddot{x}+d(x)\dot{x}+k(x)x (3)

In this case, the data of the stiffness, the viscosity, and the inertia is needed at every position. Accordingly, the number of the parameters to be managed is larger than that in the case where the sense of touch of the object is defined as the expressions (1) and (2), there is a possibility that implementation costs increase, and the amount of computation increases.

According to the present invention, the sense of touch of the object is defined as the expressions (1) and (2) accordingly, and the texture including the sense of touch of the object surface is dealt with.

### [Structure]

The structure of an apparatus for which the present invention is used will now be described.

In the case of a method of dealing with the texture that represents the sense of touch of the object surface described above, the impedance of the object to be touched is acquired, a definition based on the expressions (1) and (2) is applied, and the texture including the sense of touch of the object can be consequently provided.

The impedance of the object can be acquired, for example, from a parameter under position control, velocity control, or force control in the case where the object is touched.

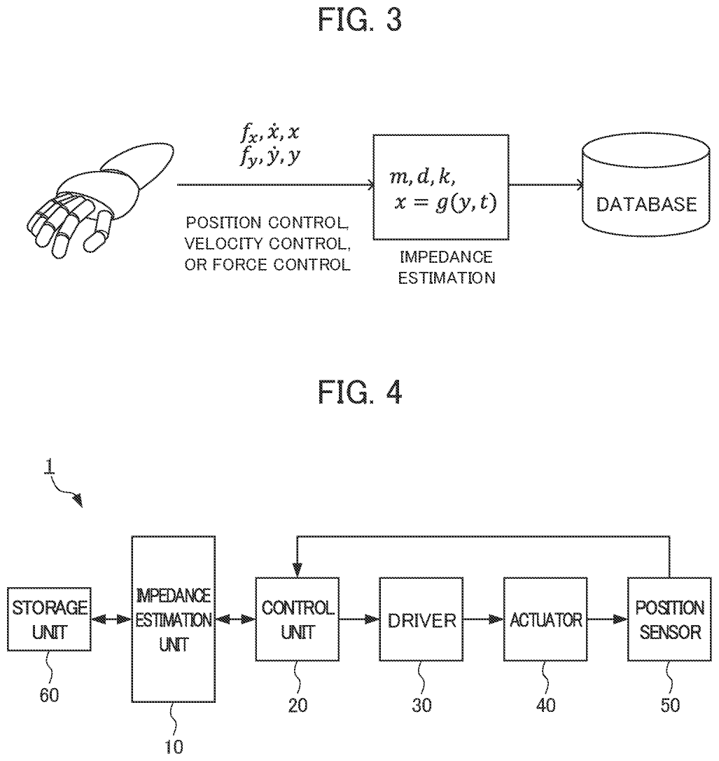

FIG. 3 schematically illustrates a state in which the impedance of the object is acquired by implementing the position control, the velocity control, or the force control.

As illustrated in FIG. 3, when a touch body (such as a robot hand) that is driven by the actuator touches the object in accordance with the position control, the velocity control, or the force control, a parameter that is generated under the control changes depending on the impedance of the object due to the reaction from the object.

A series of parameters that are generated at this time are acquired and are substituted in an equation of motion to acquire a solution, and the impedance (the stiffness, the viscosity, and the inertia) of the object to be touched can be consequently estimated.

The impedance that is acquired in this way is regarded as being inherent in the object, a value that is calculated by using the expressions (1) and (2) is used as the reference value to control the actuator, based on the position in the direction perpendicular to the plane and the position in the direction of the plane on the object surface (that is, the information about the contour of the object surface), and the texture including the sense of touch of the object can be consequently provided.

FIG. 4 is a block diagram illustrating an example of the structure of the position/force controller 1 in the case where the impedance of the object is acquired by implementing the position control, the velocity control, or the force control.

In FIG. 4, the position/force controller 1 includes an impedance estimation unit 10, a control unit 20, a driver 30, an actuator 40, a position sensor 50, and a storage unit 60.

The position/force controller 1 refers the reference value, on which an operation is based, which is stored in the storage unit 60, uses inputs of the result of detection of the output shaft (or a member that operates in conjunction with the output shaft) of the actuator 40 and the reference value, and operates depending on a function that is represented by coordinate conversion that is set in the control unit 20.

The function that is implemented in the position/force controller 1 can be changed into various functions by changing coordinate conversion that is defined in a function-dependent force/velocity distribution conversion block FT of the control unit 20 as described later. Here, a position and force control function that performs the operation of the actuator 40 corresponding to an operation that is represented by the reference value is set.

The storage unit 60 includes a storage device such as a memory or a hard disk. The storage unit 60 stores the reference value on which the operation of the position/force controller 1 is based. As for the position/force controller 1 illustrated in FIG. 4, the storage unit 60 stores the reference value that represents an operation of acquiring information about the texture including the sense of touch of the object surface while a reaction is received from the object with the object surface touched.

The storage unit 60 stores a parameter that is acquired while the control unit 20 uses the inputs of the result of detection of the output shaft (or the member that operates in conjunction with the output shaft) of the actuator 40 and the reference value and performs an operation depending on the function that is represented by the set coordinate conversion.

The storage unit 60 also stores the impedance of the object to be touched that is estimated by the impedance estimation unit 10 and the function (the expressions (1) and (2)) that defines the sense of touch. Instead of the impedance of the object to be touched and the function (the expressions (1) and (2)) that defines the sense of touch, data in the form of a table that is calculated based on these may be stored.

The impedance estimation unit 10 reads the parameter that is acquired from the storage unit 60 while the operation depending on the function that is represented by the set coordinate conversion is performed and estimates the impedance (the stiffness, the viscosity, and the inertia) of the object to be touched. For example, the impedance estimation unit 10 can estimate the impedance of the object to be touched, based on reaction force that is inputted from the object to be touched in response to the output of the actuator 40. The impedance estimation unit 10 can include an information-processing apparatus such as a CPU (Central Processing Unit) or may be a part of the control unit 20.

The control unit 20 controls the whole of the position/force controller 1 and includes an information-processing apparatus such as a CPU.

The control unit 20 carries out coordinate conversion of a parameter (such as the position of the output shaft of the actuator 40) in the real space into that in the coordinate system in which the position and the force can be independently used and performs a computation for causing the state value (the vector element) that is acquired by the coordinate conversion to follow the target value for fulfilling the function of controlling the force tactile sensation in the coordinate system. The control unit 20 carries out reverse conversion of the result of the computation in the coordinate system described above into a parameter in the real space and controls the actuator 40, based on the parameter. Consequently, the force tactile sensation including the texture that represents the sense of touch of the object surface can be provided.

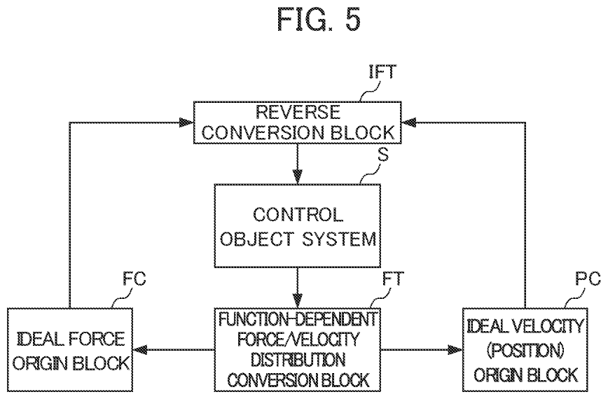

FIG. 5 is a block diagram illustrating a control algorithm that is implemented in the control unit 20.

As illustrated in FIG. 5, the algorithm that is implemented in the control unit 20 is represented as a control rule that includes the function-dependent force/velocity distribution conversion block FT, and at least an ideal force origin block FC or an ideal velocity (position) origin block PC, and a reverse conversion block IFT. According to the present embodiment, a control object system S includes the driver 30 and the actuator 40.

The function-dependent force/velocity distribution conversion block FT is a block that defines a conversion of control energy in the velocity (position) and force domains, which is specified in accordance with a function of the control object system S. Specifically, the function-dependent force/velocity distribution conversion block FT defines a coordinate conversion whose inputs are a value serving as a reference for the function of the control object system S (a reference value) and the current position of an actuator. The coordinate conversion is, generally speaking, a conversion of an input vector whose elements are a reference value of velocity (position) and a current velocity (position) to an output vector constituted with a velocity (position) for calculating a control target value of velocity (position), and a conversion of an input vector whose elements are a reference value of force and a current force to an output vector constituted with a force for calculating a control target value of force.

By the coordinate conversion by the function-dependent force/velocity distribution conversion block FT being specified in accordance with the function to be realized, various movements may be realized and movements may be reproduced with scaling.

That is, in the basic principle of the present invention, the function-dependent force/velocity distribution conversion block FT “converts” a variable of an actuator unit (a variable in real space) to a set of variables (variables in space after coordinate conversion) for the whole system representing the function to be realized, and distributes control energy to velocity (position) control energy and force control energy. Therefore, in contrast to a case in which control is performed using unmodified variables of actuator units (variables in real space), the velocity (position) control energy and force control energy may be given separately.

According to the present embodiment, as for the reference value and the inputs of the force and the position calculated from the position of the actuator 40, the computation of the state value in the space after the coordinate conversion can be performed in a condition in which a difference in position becomes zero, and the sum of the force becomes zero (the same force is outputted in opposite directions).

The ideal force origin block FC is a block that performs computations in the force domain in accordance with the coordinate conversion defined by the function-dependent force/speed distribution conversion block FT. The ideal force origin block FC sets a target value relating to force in performing a computation on the basis of the coordinate conversion defined by the function-dependent force/speed distribution conversion block FT. For example, if the function being realized is the same as the function represented by the reference value, the target value is set to zero, and if scaling is to be applied, information representing the function being reproduced is set to a magnified or reduced value.

The ideal speed (position) origin block PC sets a target value relating to speed (position) in performing a computation on the basis of the coordinate conversion defined by the function-dependent force/speed distribution conversion block FT. The target value is set as a fixed value or a variable value, depending on the function being realized. For example, if the function being realized is the same as the function represented by the reference value, the target value is set to zero, and if scaling is to be applied, information representing the function being reproduced is set to a magnified or reduced value.

The reverse conversion block IFT is a block that converts values in the speed (position) and force domains to values in an input domain for the control object system S (for example, voltage values, current values or the like).

In accordance with the control algorithm, the detection value of the position in time series that is detected by the position sensor 50 is inputted into the control unit 20. The detection value of the position in time series represents the operation of the actuator 40. For information about force and velocity (position) derived from the inputted detection value (position), the control unit 20 uses the coordinate conversion that is set depending on the function.

The driver 30 supplies specific control energy (here, electric current) to the actuator 40, based on a value that is acquired by reverse conversion carried out by the control unit 20 and that is in a domain of an input into the actuator 40.

The actuator 40 is driven by using the control energy that is supplied from the driver 30 and controls the position of an object to be controlled.

The position sensor 50 detects the position of the output shaft of the actuator 40 (or the object to be controlled) and outputs the detection value to the control unit 20.

As for the position/force controller 1 that has the structure described above, predetermined values of the position and the force can be used for the reference value that is inputted into the control unit 20. That is, the position/force controller 1 can reproduce a target function without using, for example, a master device.

### [Operation]

The operation of the position/force controller 1 will now be described.

### [Impedance Estimation Process]

An impedance estimation process for estimating the impedance of the object to be touched will be first described.

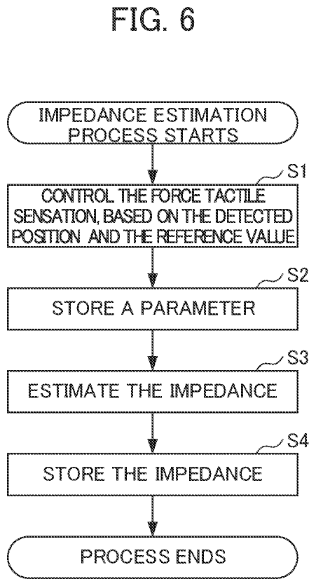

FIG. 6 is a flowchart illustrating the flow of the impedance estimation process that is performed by the position/force controller 1.

The impedance estimation process starts in response to an instruction for performing the impedance estimation process in the control unit 20.

In step S1, the control unit 20 controls the force tactile sensation, based on the position of the actuator 40 that is detected by the position sensor 50 and the reference value that is stored in the storage unit 60.

In step S2, the control unit 20 causes the storage unit 60 to store a parameter that is generated under the control of the force tactile sensation.

In step S3, the impedance estimation unit 10 refers the parameter that is generated under the control of the force tactile sensation and that is stored in the storage unit 60 and estimates the impedance of the object to be touched.

In step S4, the impedance estimation unit 10 causes the storage unit 60 to store the estimated impedance.

After the step S4, the impedance estimation process ends.

### [Force Tactile Sensation Provision Process]

A force tactile sensation provision process for providing the sense of touch of the object to be touched will now be described.

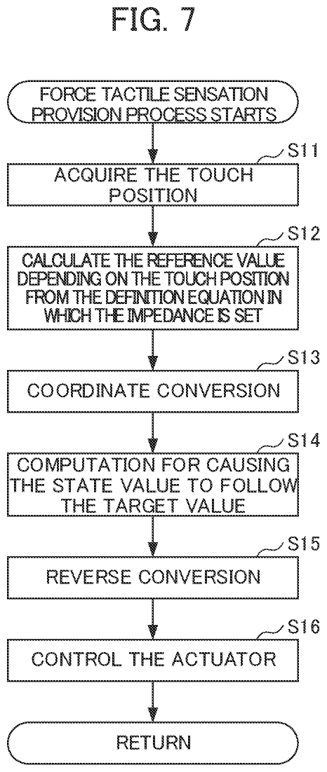

FIG. 7 is a flowchart illustrating the flow of the force tactile sensation provision process that is performed by the position/force controller 1.

The force tactile sensation provision process provides the force tactile sensation including the texture that represents the sense of touch of the object surface in the case where an object (such as a virtual object in a game that uses virtual space or a product that is sold in virtual space of e-commerce) in virtual space is touched. The force tactile sensation provision process can be used, for example, in the case where the force tactile sensation when the object in the real space is touched is reproduced later.

The force tactile sensation provision process starts in response to an instruction for performing the force tactile sensation provision process in the control unit 20.

In step S11, the control unit 20 acquires the touch position (the touch position on the virtual object) on the object to be touched.

In step S12, the control unit 20 calculates the reference value depending on the touch position on the object to be touched from the definition equation (see the expressions (1) and (2)) of the force tactile sensation in which the impedance that is stored in the storage unit 60 is set.

In step S13, the control unit 20 carries out coordinate conversion of the position of the actuator 40 and the calculated reference value into those in the coordinate system in which the position and the force can be independently used.

In step S14, the control unit 20 performs the computation for causing the state value that is acquired by the coordinate conversion to follow the target value for fulfilling the function of controlling the force tactile sensation.

In step S15, the control unit 20 carries out reverse conversion of the result of the computation in the coordinate system described above into a parameter in the real space.

In step S16, the control unit 20 controls the actuator 40, based on the parameter that is acquired by the reverse conversion.

After the step S16, the force tactile sensation provision process is repeated.

The position/force controller 1 according to the present embodiment estimates the impedance of the object to be touched, based on the parameter that is generated when the object is touched with the force tactile sensation controlled as described above. The position/force controller 1 informatizes the texture that represents the sense of touch of the object surface in a manner in which the estimated impedance (the stiffness, the viscosity, and the inertia) of the object to be touched is regarded as being inherent, and the sense of touch of the object is defined as the function depending on the position in the direction perpendicular to the plane and the position in the direction of the plane on the object surface. In the case where the position in the direction perpendicular to the plane and the position in the direction of the plane on the object surface are given as an input in the real space or the virtual space, the position/force controller 1 can provide the force tactile sensation including the texture that represents the sense of touch of the object surface in a manner in which the value that is determined by the function that defines the sense of touch of the object to be touched is inputted as the reference value, the computation for following the target value in the coordinate system described above is performed, and the output of the actuator is controlled.

Accordingly, the position/force controller 1 can appropriately acquire or provide the sense of touch of the object including the texture of the object.

In the case where the sense of touch is emphasized or reduced when the control unit 20 provides the force tactile sensation, the texture can be magnified or reduced and provided to the user, for example, by setting the reference value (or the target value after coordinate conversion) that is determined based on the function that defines the sense of touch of the object to a value depending on scaling.

### [First Modification]

An example of the structure of the position/force controller 1 described according to the above embodiment is for the case where the impedance of the object is estimated by implementing the position control, the velocity control, or the force control.

However, the structure of the position/force controller 1 can be a structure that estimates the impedance of the object by transmitting the force tactile sensation between the master and the slave.

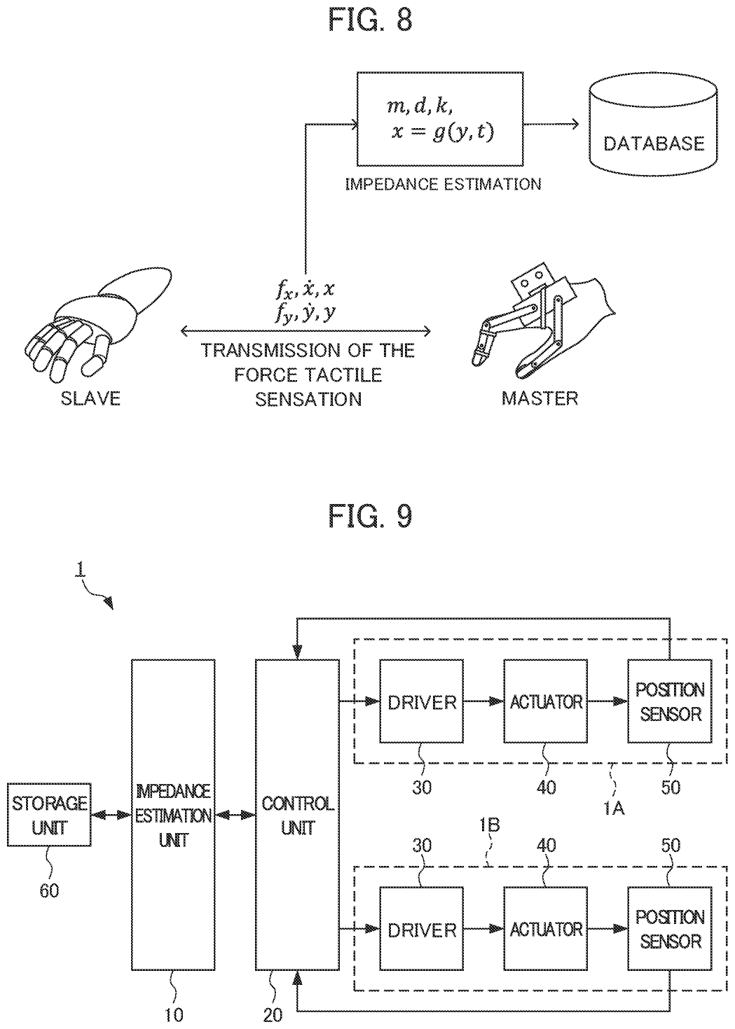

FIG. 8 schematically illustrates a state in which the impedance of the object is acquired by transmitting the force tactile sensation between the master and the slave.

As illustrated in FIG. 8, when a slave device touches the object while the force tactile sensation is transmitted between the master and the slave, a parameter that is generated during transmission of the force tactile sensation changes depending on the impedance of the object due to the reaction from the object.

A series of parameters that are generated at this time are acquired and are substituted in an equation of motion to acquire a solution, and the impedance (the stiffness, the viscosity, and the inertia) of the object to be touched can be consequently estimated.

FIG. 9 is a block diagram illustrating an example of the structure of the position/force controller 1 in the case where the impedance of the object is acquired by transmitting the force tactile sensation between the master and the slave.

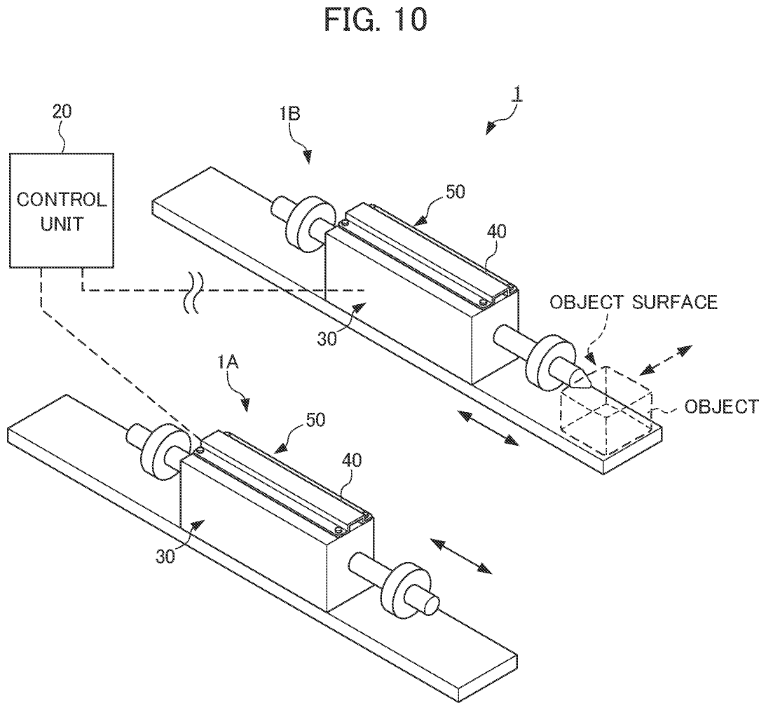

FIG. 10 schematically illustrates an example of the implementation form of the position/force controller 1 according to the present modification.

In FIG. 9 and FIG. 10, the position/force controller 1 includes the impedance estimation unit 10, the control unit 20, a master unit 1A, and a slave unit 1B. The master unit 1A and the slave unit 1B can communicate with the control unit 20 via, for example, a network.

The master unit 1A and the slave unit 1B each include the driver 30, the actuator 40, and the position sensor 50.

These structures are the same as those of the position/force controller 1 illustrated in FIG. 4. The structures of the impedance estimation unit 10 and the storage unit 60 are the same as those of the position/force controller 1 illustrated in FIG. 4.

The control unit 20 controls the whole of the position/force controller 1 and includes an information-processing apparatus such as a CPU.

The control unit 20 carries out coordinate conversion of parameters (such as the positions of the output shafts of the actuators 40 of the master unit 1A and the slave unit 1B) in the real space into those in the coordinate system in which the position and the force can be independently used and performs the computation for causing the state value (the vector element) that is acquired by the coordinate conversion to follow the target value for fulfilling the function of controlling the force tactile sensation in the coordinate system. The control unit 20 carries out reverse conversion of the result of the computation in the coordinate system described above into parameters in the real space and controls the actuators 40 of the master unit 1A and the slave unit 1B, based on the parameters. Consequently, the force tactile sensation including the texture that represents the sense of touch of the object surface can be provided in real time.

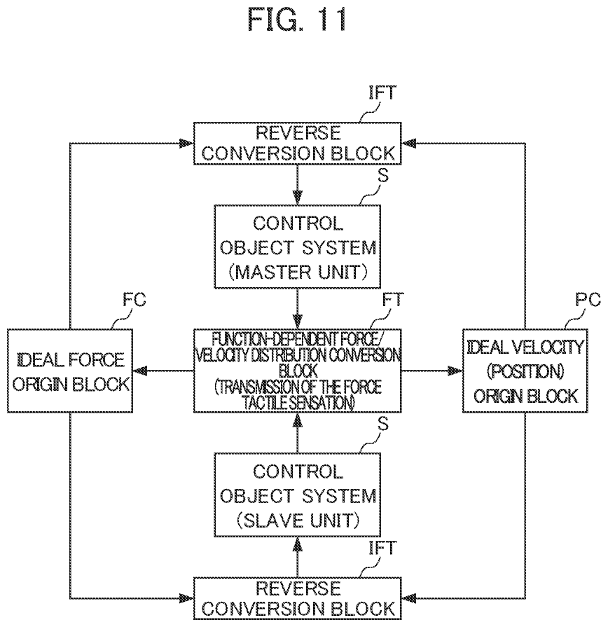

FIG. 11 is a block diagram illustrating a control algorithm that is implemented in the control unit 20 according to the first modification.

As illustrated in FIG. 11, the algorithm that is implemented in the control unit 20 according to the present modification is expressed as a control rule that includes the function-dependent force/velocity distribution conversion block FT, and at least the ideal force origin block FC or the ideal velocity (position) origin block PC, and the reverse conversion block IFT. According to the present embodiment, the control object system S includes the drivers 30 and the actuators 40 of the master unit 1A and the slave unit 1B.

The structure of each block illustrated in FIG. 11 is the same as that in the case of the control algorithm illustrated in FIG. 5.

An example of the function that is defined by the function-dependent force/velocity distribution conversion block FT that can be fulfilled by the algorithm illustrated in FIG. 11 is a function of transmitting the operation of the master unit 1A to the slave unit 1B and feeding back the input of the reaction force from the object against the slave unit 1B to the master unit 1A (a bilateral control function).

Also, the position/force controller 1 according to the present modification can perform the impedance estimation process illustrated in FIG. 6 and can estimate the impedance of the object to be touched from the parameter that is generated while the force tactile sensation is controlled between the master unit 1A and the slave unit 1B.

As for the position/force controller 1 according to the present modification, the force tactile sensation provision process illustrated in FIG. 7 can be performed for the master unit 1A or the slave unit 1B.

The position/force controller 1 according to the present embodiment includes the control unit 20 and the impedance estimation unit 10 as described above.

The control unit 20 acquires the parameter that is generated under the position and force control that is implemented in response to the touch of the object to be touched.

The impedance estimation unit 10 estimates the impedance of the object to be touched, based on the parameter that is acquired by the control unit 20.

In this way, the impedance of the object to be touched can be estimated from the parameter that is generated under the position and force control when the object to be touched is directly touched.

Accordingly, the sense of touch of the object including the texture of the object can be appropriately acquired.

Under the position and force control, conversion into the coordinate system in which the position and the force are independent is carried out based on information about the position of a member that touches the object to be touched, the computation for causing the state value in the coordinate system to follow the target values of the position and the force is performed, reverse conversion of the conversion described above is subsequently carried out on the result of the computation, and the position and force control for the object to be touched is consequently implemented.

In this way, the impedance of the object to be touched can be estimated, based on the parameter when the position and force control is more accurately implemented in the coordinate system in which the position and the force can be independently used.

The position/force controller 1 includes the position sensor 50 and the control unit 20.

The position sensor 50 acquires the position in the direction perpendicular to the plane and the position in the direction of the plane on the object surface of the object to be touched.

The control unit 20 provides the force tactile sensation including the texture that represents the sense of touch of the object surface by implementing the position and force control of the position and the force that are outputted by the actuator at the position in the direction perpendicular to the plane and the position in the direction of the plane on the object surface of the object to be touched that are acquired by the position sensor 50, based on the function that uses the impedance of the object to be touched as an eigenvalue and that uses the position in the direction perpendicular to the plane and the position in the direction of the plane on the object surface as variables for calculating the reaction force from the object to be touched.

In this way, the force tactile sensation can be provided based on a model in which the parameter that represents the impedance of the object does not change, and the reaction force from the object changes depending on the touch position (the position in the direction perpendicular to the plane and the position in the direction of the plane on the object surface).

Accordingly, the sense of touch of the object including the texture of the object can be appropriately provided.

The control unit 20 magnifies or reduces and provides the force tactile sensation including the texture that represents the sense of touch of the object surface that is determined based on the function with respect to the position in the direction perpendicular to the plane and the position in the direction of the plane on the object surface.

In this way, the sense of touch of the object surface can be emphasized or reduced and provided.

The present invention is not to be limited to the above-described embodiment. Various changes, modifications, etc. are also covered by the present invention as long as such changes, modifications, etc. fall in a range in which the object of the present invention can be achieved.

For example, in an example described according to the above embodiment, the force tactile sensation is provided by using the impedance that is estimated by the impedance estimation process, but this is not a limitation. For example, the force tactile sensation may be provided by estimating the impedance by using another method or by using the result of measurement.

In an example described above, the reference value (or the target value after coordinate conversion) that is determined based on the function that defines the sense of touch of the object is set to the value depending on scaling in the case where the sense of touch of the object surface is emphasized or reduced, but this is not a limitation. That is, another method can be used provided that the sense of touch that is provided to the user is emphasized or reduced. For example, the texture can be magnified or reduced and provided to the user, for example, by applying a gain to the input into the actuator.

The process in the embodiment and the like may be performed through hardware or software.

That is, any configuration may be employed as long as a function for performing the process described above is provided for the position/force controller 1. The functional configuration and the hardware configuration for realizing the function are not limited to the examples described above.

When the process described above is performed through software, programs constituting the software are installed from a network or a storage medium to a computer.

The storage medium that stores the program is constituted by, for example, a removable medium that is distributed separately from the device body, or a storage medium that is previously built in the device body. The removable medium is constituted by, for example, a magnetic disk, an optical disc, or a magneto-optical disk. The optical disc is constituted by, for example, a CD-ROM (Compact Disk-Read Only Memory), a DVD (Digital Versatile Disk), or a Blu-ray Disc (trademark). The magneto-optical disk is constituted by, for example, a MD (Mini-Disk). The storage medium that is previously built in the device body is constituted by, for example, ROM or a hard disk in which the program is stored.

The above embodiment is an example to which the present invention is applied, and does not limit the technical scope of the present invention. That is, the present invention may be subjected to various modifications such as omission and replacement without deviating from the spirit of thereof, and various embodiments other than that described above may be implemented. Various embodiments and modifications thereof that can be implemented in the present invention are included in the scope of the invention described in the claims and an equivalent scope.

### REFERENCE SIGNS LIST

1 position/force controller, 10 impedance estimation unit, 20 control unit, 30 driver, 40 actuator, 50 position sensor, 60 storage unit, FT function-dependent force/velocity distribution conversion block, FC ideal force origin block, PC ideal velocity (position) origin block, IFT reverse conversion block, S control object system

1. A position/force controller comprising:
a parameter acquirer that acquires a parameter that is generated under position and force control that is implemented in response to a touch of an object to be touched; and
an impedance estimator that estimates impedance of the object to be touched, based on the parameter that is acquired by the parameter acquirer.

2. The position/force controller according to claim 1, wherein under the position and force control, conversion into a coordinate system in which a position and force are independent is carried out based on information about a position of a member that touches the object to be touched, a computation for causing a state value in the coordinate system to follow target values of the position and the force is performed, reverse conversion of the conversion is subsequently carried out on a result of the computation, and the position and force control for the object to be touched is consequently implemented.

3. A position/force controller comprising:
a position acquirer that acquires a position in a direction perpendicular to a plane and a position in a direction of the plane on an object surface of an object to be touched; and
a force tactile sensation provider that provides force tactile sensation including texture that represents sense of touch of the object surface by implementing position and force control of a position and force that are outputted by an actuator at the position in the direction perpendicular to the plane and the position in the direction of the plane on the object surface of the object to be touched that are acquired by the position acquirer, based on a function that uses impedance of the object to be touched as an eigenvalue and that uses the position in the direction perpendicular to the plane and the position in the direction of the plane on the object surface as variables for calculating reaction force from the object to be touched.

4. The position/force controller according to claim 3, wherein the force tactile sensation provider magnifies or reduces and provides the force tactile sensation including the texture that represents the sense of touch of the object surface that is determined based on the function with respect to the position in the direction perpendicular to the plane and the position in the direction of the plane on the object surface.

5. A position/force control method comprising:
a parameter acquisition process including acquiring a parameter that is generated under position and force control that is implemented in response to a touch of an object to be touched; and
an impedance estimation process including estimating impedance of the object to be touched, based on the parameter that is acquired at the parameter acquisition process.

6. A position/force control method comprising:
a position acquisition process including acquiring a position in a direction perpendicular to a plane and a position in a direction of the plane on an object surface of an object to be touched; and
a force tactile sensation provision process including providing force tactile sensation including texture that represents sense of touch of the object surface by implementing position and force control of a position and force that are outputted by an actuator at the position in the direction perpendicular to the plane and the position in the direction of the plane on the object surface of the object to be touched that are acquired at the position acquisition process, based on a function that uses impedance of the object to be touched as an eigenvalue and that uses the position in the direction perpendicular to the plane and the position in the direction of the plane on the object surface as variables for calculating reaction force from the object to be touched.

7. A non-transitory storage medium encoded with a computer-readable program that controls a processor of a computer to execute operations comprising:
a parameter acquisition processing including acquiring a parameter that is generated under position and force control that is implemented in response to a touch of an object to be touched, and
an impedance estimation processing including estimating impedance of the object to be touched, based on the parameter that is acquired by the parameter acquisition processing.

8. A program causing a computer to realize:
a position acquisition processing including acquiring a position in a direction perpendicular to a plane and a position in a direction of the plane on an object surface of an object to be touched, and
a force tactile sensation provision processing including providing force tactile sensation including texture that represents sense of touch of the object surface by implementing position and force control of a position and force that are outputted by an actuator at the position in the direction perpendicular to the plane and the position in the direction of the plane on the object surface of the object to be touched that are acquired by the position acquisition processing, based on a function that uses impedance of the object to be touched as an eigenvalue and that uses the position in the direction perpendicular to the plane and the position in the direction of the plane on the object surface as variables for calculating reaction force from the object to be touched.
